(19) United States
(12) Patent Application Publication
(10) Pub. No.: US 2009/0327062 A1
(43) Pub. Date: Dec. 31, 2009

(54) METHODS AND SYSTEMS FOR OPTIMAL PRICING

(76) Inventor: Andries Stephanus BOTES, Witelsbos (ZA)

Correspondence Address: Ballard Spahr LLP, SUITE 1000, 999 PEACHTREE STREET, ATLANTA, GA, 30309-3915, US

(21) Appl. No.: 11/991,031

(22) PCT Filed: Aug. 28, 2006
(86) PCT No.: PCT/US2006/033675

§ 371 Date: Apr. 30, 2009

Related U.S. Application Data
(60) Provisional application No. 60/712,028, filed on Aug. 26, 2005.

(51) Int. Cl. G06Q 30/00; G06Q 10/00; G06Q 20/00

(52) U.S. Cl. 705/14.17; 705/30; 705/14.34; 705/14.27; 705/26; 705/400

(57) ABSTRACT

The systems and methods disclosed relate to the buying and selling of products. More particularly, the systems and methods relate to providing all buyers with the cost savings benefit of economies of scale. Economy of scale benefits involve unit (product) cost reductions which result from increasing total unit output, or sales. Typically, as a seller sells more of a unit, the cost per unit will eventually decline. Such a system discourages initial buyers and rewards later buyers. The present systems and methods can provide economy of scale benefits to all buyers and sellers of products.

### BACKGROUND OF THE INVENTION

Manufacturers and Sellers all have a problem establishing a price point for their products and services. This problem is caused by the inability to predict the volume in which a product or service may sell and therefore, what should be charged to cover costs plus profit. Once economies of scale occur and manufacturers and sellers have recovered their costs plus profit minimum margin, prices can be reduced. This price reduction penalizes early adopters (the initial purchasers) and rewards the late-corners who purchase after economies of scale occur. This scenario causes buyers to be reluctant to purchase, as they expect a price to ultimately be reduced, so they wait to buy after the price reduction.

Methods and systems that assure each purchaser that they will pay, and will have paid, the lowest possible price for a product or service, either by immediate quote or credits and refunds, will encourage buyers to purchase sooner rather than later, as a portion of each subsequent sale of the product will be refunded to previous purchasers.

### SUMMARY OF THE INVENTION

The systems and methods disclosed relate to the buying and selling of products. More particularly, the systems and methods relate to providing buyers with the cost savings benefit of economies of scale. Economy of scale benefits involve unit (product) cost reductions which result from increasing total unit output, or sales. Typically, as a seller sells more units, the cost per unit will eventually decline and so will the sale price. Such a system discourages initial buyers and rewards later buyers. The present systems and methods can provide economy of scale benefits to all buyers of products.

Additional advantages of the invention are set forth in part in the description which follows. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and together with the description, serve to explain the principles of the invention.

FIG. 1 is an illustrative operating environment.

FIG. 2 is an illustrative business transaction environment.

FIG. 3 is a logic flow diagram illustrating the basic steps of an exemplary method.

FIG. 4 illustrates the general steps of the method.

FIG. 5 illustrates an exemplary linear price reduction.

### DETAILED DESCRIPTION OF THE INVENTION

Before the present methods and systems are disclosed and described, it is to be understood that this invention is not limited to specific synthetic method or specific components. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Thus, for example, reference to “a processor” includes mixtures of processors, reference to “a processor” includes mixtures of two or more such processors, and the like.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

The present invention may be understood more readily by reference to the following detailed description of preferred embodiments of the invention and the examples included therein and to the Figures and their previous and following description. The systems and methods disclosed relate to the buying and selling of products. More particularly, the systems and methods relate to providing all buyers with the cost savings benefit of economies of scale. Economy of scale benefits involve unit (product) cost reductions which result from increasing total unit output, or sales. Typically, as a seller sells more of a unit, the cost per unit will eventually decline. Such a system discourages initial buyers and rewards later buyers. The present systems and methods can provide economy of scale benefits to all buyers of products.

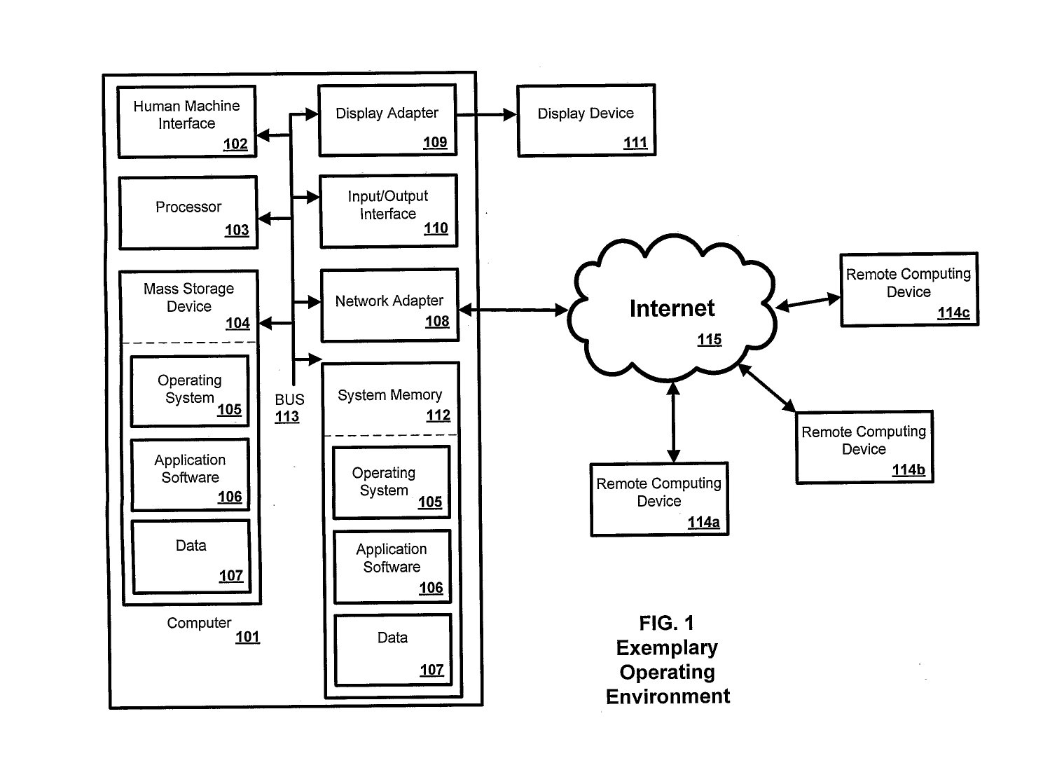

FIG. 1 is a block diagram illustrating an exemplary operating environment for performing the disclosed method. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The method can be operational with numerous other general purpose or special purpose computing system environments or configurations. Examples of well known computing systems, environments, and/or configurations that may be suitable for use with the system and method include, but are not limited to, personal computers, server computers, laptop devices, and multiprocessor systems. Additional examples include set top boxes, programmable consumer electronics, network PCs, minicomputers, mainframe computers, distributed computing environments that include any of the above systems or devices, and the like.

The method may be described in the general context of computer instructions, such as program modules, being executed by a computer. Generally, program modules include routines, programs, objects, components, data structures, etc., that perform particular tasks or implement particular abstract data types. The system and method may also be practiced in distributed computing environments where tasks are performed by remote processing devices that are linked through a communications network. In a distributed computing environment, program modules may be located in both local and remote computer storage media including memory storage devices.

The method disclosed herein can be implemented via a general-purpose computing device in the form of a computer 101. The components of the computer 101 can include, but are not limited to, one or more processors or processing units 103, a system memory 112, and a system bus 113 that couples various system components including the processor 103 to the system memory 112.

The system bus 113 represents one or more of several possible types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus. This bus, and all buses specified in this description can also be implemented over a wired or wireless network connection. The bus 113, and all buses specified in this description can also be implemented over a wired or wireless network connection and each of the subsystems, including the processor 103, a mass storage device 104, an operating system 105, application software 106, data 107, a network adapter 108, system memory 112, an Input/Output Interface 110, a display adapter 109, a display device 111, and a human machine interface 102, can be contained within one or more remote computing devices 115a,b,c at physically separate locations, connected through buses of this form, in effect implementing a fully distributed system.

The computer 101 typically includes a variety of computer readable media. Such media can be any available media that is accessible by the computer 101 and includes both volatile and non-volatile media, removable and non-removable media. The system memory 112 includes computer readable media in the form of volatile memory, such as random access memory (RAM), and/or non-volatile memory, such as read only memory (ROM). The system memory 112 typically contains data such as data 107 and/or program modules such as operating system 105 and application software 106 that are immediately accessible to and/or are presently operated on by the processing unit 103.

The computer 101 may also include other removable/non-removable, volatile/non-volatile computer storage media. By way of example, FIG. 1 illustrates a mass storage device 104 which can provide non-volatile storage of computer code, computer readable instructions, data structures, program modules, and other data for the computer 101. For example, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules can be stored on the mass storage device 104, including by way of example, an operating system 105 and application software 106. Each of the operating system 105 and application software 106 (or some combination thereof) may include elements of the programming and the application software 106. Data 107 can also be stored on the mass storage device 104. Data 107 can be stored in any of one or more databases known in the art. Examples of such databases include, DB2®, Microsoft® Access, Microsoft® SQL Server, Oracle®, mySQL, PostgreSQL, and the like. The databases can be centralized or distributed across multiple systems.

A user can enter commands and information into the computer 101 via an input device (not shown). Examples of such input devices include, but are not limited to, a keyboard, pointing device (e.g., a “mouse”), a microphone, a joystick, a serial port, a scanner, and the like. These and other input devices can be connected to the processing unit 103 via a human machine interface 102 that is coupled to the system bus 113, but may be connected by other interface and bus structures, such as a parallel port, game port, or a universal serial bus (USB).

A display device 111 can also be connected to the system bus 113 via an interface, such as a display adapter 109. For example, a display device can be a monitor or an LCD (Liquid Crystal Display). In addition to the display device 111, other output peripheral devices can include components such as speakers (not shown) and a printer (not shown) which can be connected to the computer 101 via Input/Output Interface 110.

The computer 101 can operate in a networked environment using logical connections to one or more remote computing devices 115a, b, c. By way of example, a remote computing device can be a personal computer, portable computer, a server, a router, a network computer, a peer device or other common network node, and so on. Logical connections between the computer 101 and a remote computing device 115a,b,c can be made via a local area network (LAN) and a general wide area network (WAN). Such network connections can be through a network adapter 108. A network adapter 108 can be implemented in both wired and wireless environments. Such networking environments are commonplace in offices, enterprise-wide computer networks, intranets, and the Internet 115.

For purposes of illustration, application programs and other executable program components such as the operating system 105 are illustrated herein as discrete blocks, although it is recognized that such programs and components reside at various times in different storage components of the computing device 101, and are executed by the data processor(s) of the computer. An implementation of application software 106 may be stored on or transmitted across some form of computer readable media. Computer readable media can be any available media that can be accessed by a computer. By way of example, and not limitation, computer readable media may comprise “computer storage media” and “communications media.” “Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The processing of the disclosed method can be performed by software components. The disclosed method may be described in the general context of computer-executable instructions, such as program modules, being executed by one or more computers or other devices. Generally, program modules include computer code, routines, programs, objects, components, data structures, etc. that performs particular tasks or implements particular abstract data types. The disclosed method may also be practiced in grid-based and distributed computing environments where tasks are performed by remote processing devices that are linked through a communications network. In a distributed computing environment, program modules may be located in both local and remote computer storage media including memory storage devices.

In one aspect, provided is a method for providing cost savings benefit of economies of scale, comprising providing, by a seller, an item with an item sales price purchasing, by a buyer, the item from the seller, determining a new item sales price based on a price reduction parameter, determining an amount to credit a previous buyer, and crediting the previous buyer the determined amount. The method can further comprise determining seller revenue, determining revenue earned by a host, said host configured for storing buyer data and seller data, crediting the seller, and crediting the host.

The item sales price can be set to an initial price determined by the seller, if the item has not been previously purchased or a calculated sales price, if the item has been previously purchased. The buyer can make the purchase at a point of sale/brick-and-mortar environment. The buyer makes the purchase over a network. The price reduction parameter can be selected from the group consisting of stepped, linear, hyperbolic, and parabolic.

Determining an amount to credit a previous buyer can comprise determining a difference in the price paid by the buyer and the price paid by the previous buyer and adding, to the determined difference, a percentage of the price paid by the buyer.

The method can further comprise transferring the determined amount to the previous buyers wherein the transfer is selected from a group consisting of a credit back to a credit card, a deposit into a bank account, a deposit into an account maintained by the buyer with the host, a deposit in to an electronic funds service account, a check mailed to the buyer, and cash.

The calculated sales price can be equal to a previous sales price if the previous sales price is a final minimum price set by the seller or if the price reduction parameter has not been met.

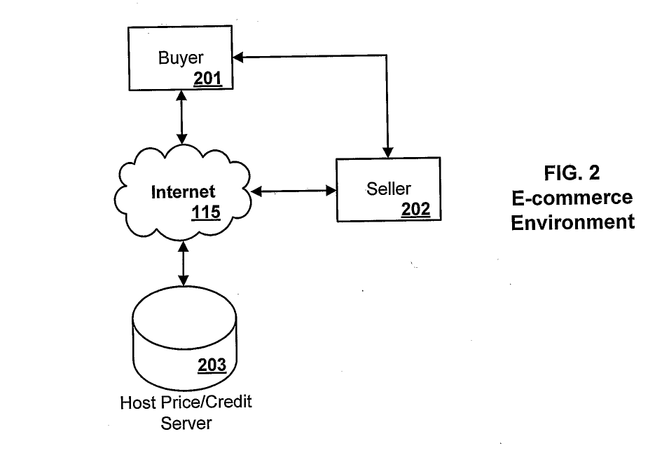

The present methods can be implemented in a typical “e-commerce” environment, in other words, the conducting of business communication and transactions over networks and through computers; the buying and selling of goods and services, and the transfer of funds, through digital communications. However, the methods can also be implemented in traditional point-of-sale/brick-and-mortar environments. FIG. 2 illustrates an exemplary e-commerce environment/system wherein the methods of the invention can be implemented. Buyers 201 and Sellers 202 can register with a Host 203 via the Internet 115. The Host 203 can be a web server containing a database for processing requests and for performing various steps of the methods.

By way of example, not limitation, typical Buyer 201 data can be as follows:
user ID
password
last name
middle name
first name
title
company name (if a company is the buyer 201)
company Federal Employer Identification Number (if a company is the buyer 201)
Social Security Number (or other unique identifier)
address, phone numbers and email
representations and acceptance of terms
banking details
credit card information

By way of example, not limitation, typical Seller 202 data can be as follows:
user id
password
business name
business type (Corporation, C-Corporation, LLC etc.)
DBA name (if applicable)
Federal Employer Identification Number
address, phone numbers and email
representations and acceptance of terms
bank details
account balance
Sale Item items:
   Sale Item description
   Sale Item SKU number
   Number of units for sale
   Starting sale price
   Starting sale date
   Ending sales date
   Minimum accepted price
   Method of decrease (price reduction parameter) hyperbolic, linear, stepped, or parabolic
   Percentage decrease per step
   Total percentage to decrease
   Percentage and/or amount of credit
   Number of step between Starting sale price and Minimum accepted price
   Number of units per step
   Interest rate
   Days in inventory
   Open for bid
   Bid automatic acceptance price
   Bid expiration
   Percentage markup
   Minimum margin
   Credit Rules

Other data that can be maintained includes:
Buyer's 201 items purchased history
Seller's 202 items listed history
Item details:
   SKU number
   Item pictures/graphics/description
   Price decrease history, date and time reduced.
   Current Price
   Open bid
   Number of units sold, today, week to date, month to date, year to date, in total
   Comparative sale items

The buyer 201, seller 202, and other data can be stored in any of one or more databases known in the art at the Host 203. Examples of such databases include, DB2®, Microsoft® Access, Microsoft® SQL Server, Oracle®, mySQL, PostgreSQL, and the like. The databases can be centralized or distributed across multiple systems.

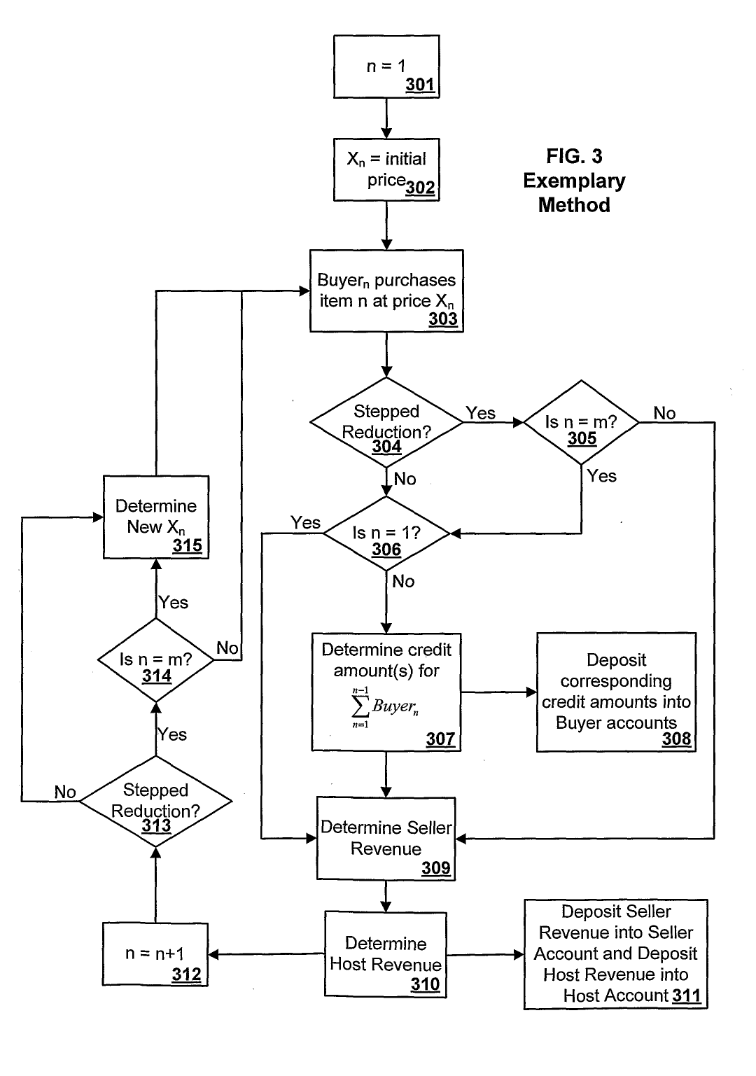

In FIG. 2, a buyer 201 can browse or search a seller's 202 items for sale. The items can have item information associated with the item. Item information can comprise the aforementioned sale item data. The buyer 201 can view items for sale at a seller's 202 e-commerce website, a seller's 202 physical location, or the seller 202 can maintain an e-commerce website hosted by the host 203. As the buyer 201 is viewing seller's 202 items with associated item information, the buyer 201 is also presented with an item sale price. An exemplary method for sales price generation is described in detail below and in FIG. 3. The buyer 201 can be presented with the item sale price in several ways. The item sale price can be generated “on the fly” each time the item is viewed by the seller 202 website contacting the host 203 for the current sales price. The item sales price can alternatively be displayed after the buyer 201 clicks on a link, button or similar interaction means whereby the host 203 is then contacted to generate the most current price for the item. In a retail store environment, the buyer 201 can present the item to the seller 202, whereby the seller 202 can contact the host 203 for the most current price. Once the buyer 201 has been presented with the most current price for the item, the buyer 201 can complete the purchase if he/she so chooses.

FIG. 3 provides steps for an exemplary method of calculating a current price for a sales item. The order of the following steps can be varied. The variables used in FIG. 3 can be defined as follows:
n=current purchase iteration
Buyerₙ=buyer at iteration n, note that a buyer can make multiple purchases of the same item, allowing one buyer to in effect be represented as multiple buyers for the purposes of price determination
Xₙ=sales price at iteration n
Xₙ₋₁=sale price at iteration n−1
L=reduction %
m=step
C=fixed reduction amount
R_{f}=credit amount
R_{b}=credit percentage

The first time a system calculates a current price, n is set equal to one 301. Then, at block 302, Xₙ can be set equal to an initial price, predetermined by a seller 202. A buyerₙ 201 can purchase an item at the current price of Xₙ 303. The sales price of the first purchase of the item can be equal to the initial price set by the seller 202. Once the item is purchased, the system can determine a new price for the item based on a price reduction parameter. Examples of price reduction parameters include, but are not limited to, stepped, linear, hyperbolic, and parabolic. For example, the system can determine if a stepped price reduction is in effect. The selection of stepped price reduction as the price reduction parameter can be specified by a seller 202 at the time an item is listed with the host 203, or any time thereafter. The host specifies that after every mth item sold, change the price. For example, m can be 4, allowing a price change every fourth item sold. If, at block 304, a stepped reduction has been specified, the system can determine at block 305 whether n=m. If n does not equal m, the system proceeds to determine seller revenue at block 309, discussed below. If n=m, the system proceeds to block 306. The system can check if n=1 at block 306. If n is equal to one, then this is the first item sold, and the system proceeds to block 309 to determine seller revenue, discussed in more detail below. If n does not equal one, the system proceeds to block 307 to determine credit amounts for all preceding buyers 201

$${\sum }_{n = 1}^{n - 1} {Buyer}_{n} .$$

The credit amounts provided to the previous buyers can be determined several ways. The credit amount for a previous buyer can be the difference in the price paid by the current buyer and the price paid by the buyer immediately preceding that buyer, plus a percentage of the price paid by the current buyer. The credit amounts can be calculated by, for each previous Buyerₙ, for n>1, R_{f}=Xₙ₋₁−Xₙ+R_{b}*Xₙ. Alternatively, the credit amounts can be only a percentage of the purchase price. The credit amount for a previous buyer can also be only the difference in the price paid by the current buyer and the price paid by the buyer immediately preceding that buyer. The credit amounts for each buyer 201 are transferred to the corresponding buyer 201 at block 308. This transfer can take multiple forms. The transfer can be a credit back to a credit card, an automatic deposit into a bank account, an automatic deposit into an account maintained for the buyer 201 at the host 202, a deposit into an electronic funds transfer service account such as Paypal®, a physical check mailed to the buyer 201, cash, and the like. Credits made to buyers 201 at the time of purchase are similar to rebates. The credit amount can alternatively not be paid until a buyer's 201 account has reached a pre-determined threshold amount. A buyer 201 can choose to pay a seller 202 with balance available on a buyer's 201 account with host 203.

The system also proceeds to determine seller revenue at block 309. If, at block 306, n equals one, then no credits are due and the system skips to block 309 to determine seller revenue. At block 309, seller revenue can be the amount remaining from a sale after credits, if any, have been paid. The seller revenue can be less than this amount, for instance, if a percentage of purchases are donated to a charitable cause. Alternatively, seller revenue can be a percentage of the sales price or a fixed amount of the sales price. If the seller revenue is not equal to the amount left over after credits have been paid, the remaining amount can be placed into a refund reserve to ensure the remaining credits can draw from sufficient funds to be paid.

The system then proceeds to block 310 to determine the host revenue. Host revenue can be a percentage of the seller revenue, for example 2%, a fixed amount of the seller revenue per sale, for example $1.00, a fixed amount of the seller revenue per number of sales, for example $3.00 per 5 sales, and the like. The host revenue can be taken from the seller revenue determined in block 309.

Once the host revenue is determined, the system can deposit the seller revenue into seller accounts and the system can deposit host revenue into a host account at block 311. Such deposits can be made in the same fashion as described above for credit amount transfers. The system proceeds to block 312, setting n=n+1. The system then performs a check to determine if the change in Xₙ is based on a stepped reduction 313. A stepped reduction is specified by a seller 202 at the time an item is listed with the host 203, or any time thereafter. The host specifies that after every mth item sold, change the price. For example, m can be 4, allowing a price change every fourth item sold. If, at block 313, a stepped reduction has not been specified, the system determines a new Xₙ at block 315. If a stepped reduction has been specified, the system performs a check to determine if the number of the current item sold is equal to the step amount, n=m. If n does not equal m, the system returns to block 303, to await the next purchase. If n=m, the system determines a new Xₙ at block 315.

At block 315, a new Xₙ is determined. A new Xₙ can be determined in a variety of ways. For example, a new Xₙ can be determined in a hyperbolic fashion by, for all n>1, setting Xₙ=Xₙ₋₁−(Xₙ₋₁*L). Alternatively, a new Xₙ can be determined in a linear fashion by, for all n>1, setting Xₙ=Xₙ₋₁−C. Yet another method for determining a new Xₙ can be the initial price minus the minimum price, divided by a number of price breaks=credit amount. The price is reduced by the credit amount for every subsequent buyer, crediting previous buyers, until the minimum price is reached. Once the new Xₙ is determined, the system returns to block 303, to await the next purchase.

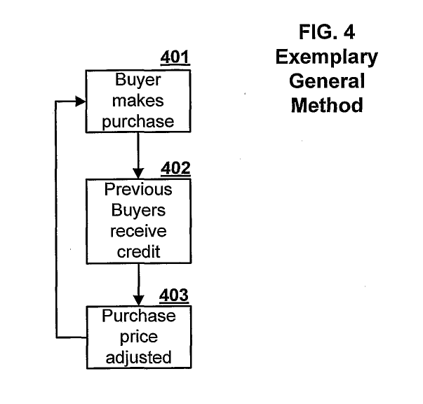

FIG. 4 illustrates the general steps of the method. The method can comprise a buyer making a purchase 401, crediting the previous purchasers 402, and adjusting the purchase price 403. Step 403 in FIG. 4 can be performed before step 402.

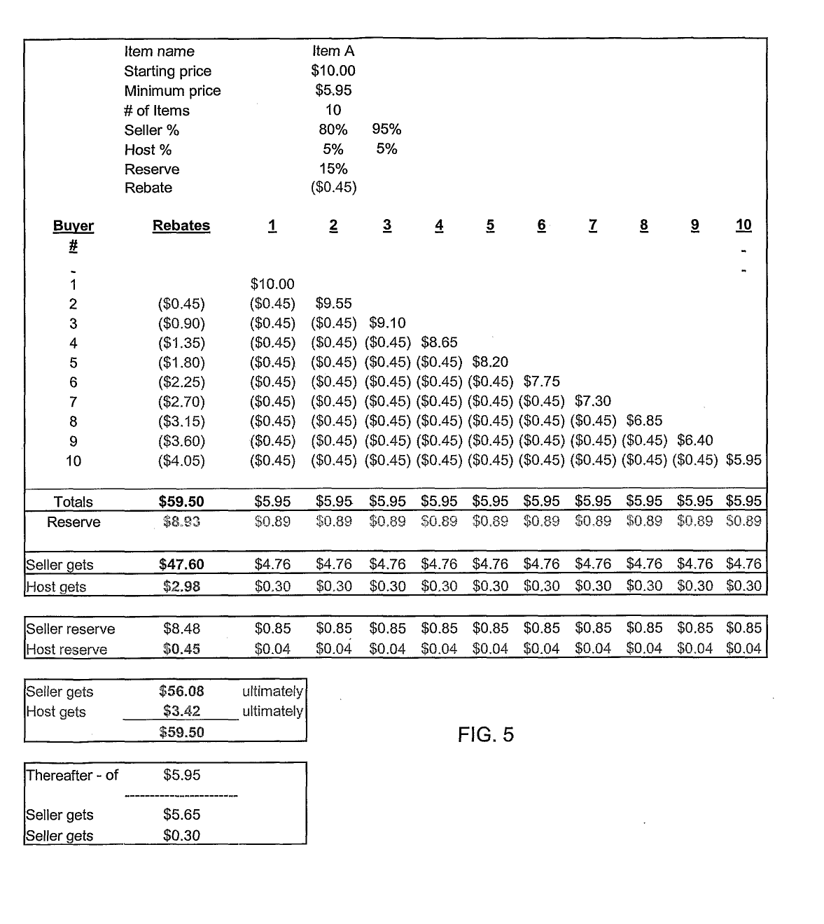

FIG. 5 illustrates an exemplary linear price reduction. For an exemplary item, Item A, there is a starting price of $10.00 and a minimum price goal of $5.99. Economies of scale will be in effect by the time the 10^{th} item has sold. The previous buyers will receive a $0.45 credit for each item sold after their purchase until the 10^{th} item has sold. The seller will receive 80% revenue, plus any revenue remaining after the host receives 5% revenue. The final price, after credits and sales is $5.95.

### EXAMPLES

The following examples are put forth so as to provide those of ordinary skill in the art with a complete disclosure and description of how the systems and methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for.

### Example Transactions

Buyer Buying Directly from Host's Website:
1. Host displays transaction details, allowing Buyer to edit transaction details.
2. Buyer accepts transaction details.
3. Host processes credit card transaction or charges sale to Buyer's account with Host.
4. Host returns confirmation code to Buyer
5. Host forwards copy of transaction to Seller
6. Seller does fulfillment
7. Host then allocates credits to all previous Buyers of the particular Sale Item, according to rules dictated by the Seller
8. Host credits Seller bank account with payment, minus Host fees.
   Buyer Paying Seller with Cash:
1. Hosts display transaction details to Seller for Buyer acceptance
2. Host clears credit card transaction charging Sellers credit card account
3. Seller collects cash from Buyer
4. Seller delivers sale item
5. Host then allocates credits to all previous Buyers of the particular Sale Item, according to rules dictated by the Seller
6. Host credits Seller's account and deposits it in Seller's bank account periodically.
   Buyer Paying Seller with Credit Card:
1. Hosts display transaction details to Seller for Buyer acceptance.
2. Hosts clears Buyer credit card transaction.
3. Host forwards copy of transaction to Seller.
4. Seller does fulfillment.
5. Host credits Seller's account and deposits it in Seller's bank account periodically.
6. Host allocates credits to all previous Buyers of the particular sale Item.

While this invention has been described in connection with preferred embodiments and specific examples, it is not intended that the scope of the invention be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from granunatical organization or punctuation; the number or type of embodiments described in the specification. Additionally, the methods disclosed herein can be practiced outside the context of a computer operating environments.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method for providing cost savings benefit of economies of scale, comprising:
providing, by a seller, an item with an item sales price;
purchasing, by a buyer, the item from the seller;
determining a new item sales price based on a price reduction parameter;
determining an amount to credit a previous buyer; and
crediting the previous buyer the determined amount.

2. The method of claim 1, further comprising:
determining seller revenue;
determining revenue earned by a host, said host configured for storing buyer data and seller data;
crediting the seller; and
crediting the host.

3. The method of claim 1, wherein the price reduction parameter is selected from the group consisting of:
stepped;
linear;
hyperbolic; and
parabolic.

4. The method of claim 1, wherein the buyer makes the purchase at a point of sale/brick-and-mortar environment.

5. The method of claim 1, wherein the buyer makes the purchase over a network.

6. The method of claim 1, wherein determining an amount to credit a previous buyer comprises:
determining a difference in the price paid by the buyer and the price paid by the previous buyer; and
adding, to the determined difference, a percentage of the price paid by the buyer.

7. The method of claim 1, further comprising transferring the determined amount to the previous buyers wherein the transfer is selected from a group consisting of a credit back to a credit card, a deposit into a bank account, a deposit into an account maintained by the buyer with the host, a deposit in to an electronic funds service account, a check mailed to the buyer, and cash.

8. The method of claim 1, wherein the item sales price is set to an initial price determined by the seller, if the item has not been previously purchased or a calculated sales price, if the item has been previously purchased.

9. The method of claim 8, wherein the calculated sales price is equal to a previous sales price if the previous sales price is a final minimum price set by the seller or if the price reduction parameter has not been met.

10. A system for providing a cost savings benefit of economies of scale, comprising:
a memory configured to store item data, seller data, and buyer data; and
a processor, coupled to the memory, wherein the processor is configured to perform a method comprising:
providing an item with an item sales price;
receiving finds for an item purchase;
determining a new item sales price based on a price reduction parameter;
determining an amount to credit a previous buyer; and
crediting the previous buyer the determined amount.

11. The system of claim 10, further comprising:
determining seller revenue; and
determining revenue earned by a host, said host configured for storing buyer data and seller data;
crediting the seller; and
crediting the host.

12. The method of claim 10, wherein the price reduction parameter is selected from the group consisting of:
stepped;
linear;
hyperbolic; and
parabolic.

13. The system of claim 10, wherein determining a new item sales price comprises a stepped price reduction, whereby the item sales price is adjusted when a specified number of the item has been purchased.

14. The system of claim 10, wherein the buyer makes the purchase at a point of sale/brick-and-mortar environment.

15. The system of claim 10, wherein the buyer makes the purchase over a network.

16. The system of claim 10, wherein determining an amount to credit a previous buyer comprises:
determining a difference in the price paid by the buyer and the price paid by the previous buyer; and
adding, to the determined difference, a percentage of the price paid by the buyer.

17. The system of claim 10, further comprising transferring the determined amount to the previous buyers wherein the transfer is selected from a group consisting of a credit back to a credit card, a deposit into a bank account, a deposit into an account maintained by the buyer with the host, a deposit in to an electronic funds service account, a check mailed to the buyer, and cash.

18. The system of claim 10, wherein the item sales price is set to an initial price determined by the seller, if the item has not been previously purchased or a calculated sales price, if the item has been previously purchased.

19. The system of claim 18, wherein the calculated sales price is equal to a previous sales price if the previous sales price is a final minimum price set by the seller or if the price reduction parameter has not been met.

20. A computer readable medium having computer executable instructions embodied thereon, the computer executable instructions configured for performing a method comprising:
providing, by a seller, an item with an item sales price;
purchasing, by a buyer, the item from the seller;
determining a new item sales price;
determining an amount to credit a previous buyer; and
crediting the previous buyer the determined amount.
